(19) United States
(12) Patent Application Publication
(10) Pub. No.: US 2026/0008468 A1
(43) Pub. Date: Jan. 8, 2026

(54) VEHICLE CONTROL APPARATUS AND METHOD THEREOF

(71) Applicants: HYUNDAI MOTOR COMPANY, SEOUL (KR); KIA CORPORATION, SEOUL (KR)

(72) Inventors: Min Seok SONG, Hwaseong-si (KR); Hyeon Jun LEE, Hwaseong-si (KR); Hyeon Woo KIM, Hwaseong-si (KR); Ji Seop LEE, Hwaseong-si (KR)

(21) Appl. No.: 18/951,340

(22) Filed: Nov. 18, 2024

(30) Foreign Application Priority Data
Jul. 5, 2024 (KR) 10-2024-0089030

(51) Int. Cl. B60W 30/182; B60L 58/12; B60W 20/12; B60W 50/00

(52) U.S. Cl. CPC B60W 30/182; B60L 58/12; B60W 20/12; B60W 50/0097; B60L 2240/12; B60L 2240/642; B60L 2240/66; B60L 2260/26; B60L 2260/50; B60W 2050/0083; B60W 2510/244; B60W 2520/10; B60W 2520/30; B60W 2552/15; B60W 2555/20

(57) ABSTRACT

A vehicle control apparatus is provided that includes an engine, a battery, a processor, and a memory. The processor predicts a change in speed of a vehicle according to a route of the vehicle, divides the route into a plurality of sections using the change in speed, obtains power information of the vehicle which will vary based on the change in speed. The processor then, for each of the plurality of sections, determines reference power to maintain driving of the engine while driving the vehicle in each of the plurality of sections, using the power information corresponding to each of the plurality of sections, and controls the vehicle, based on at least one of an electric vehicle (EV) mode determined according to the reference power or a hybrid electric vehicle (HEV) mode determined according to the reference power, or any combination thereof.

### CROSS-REFERENCE TO RELATED APPLICATION

This application claims the benefit of priority to Korean Patent Application No. 10-2024-0089030, filed in the Korean Intellectual Property Office on Jul. 5, 2024, the entire contents of which are incorporated herein by reference.

### TECHNICAL FIELD

The present disclosure relates to a vehicle control apparatus and a method thereof, and more particularly, relates to technologies for selecting a mode for controlling a vehicle.

### BACKGROUND

Recently, a technology for controlling a mode of a vehicle depending on a state of charge (SOC) of a battery has been studied. Such a technology may implement SOC charging power when predicting the discharging of the SOC and may apply an SOC discharging strategy if predicting over-charging of the Soc, thus adjusting the SOC. In this regard, because a technology for controlling a mode of a vehicle is able to be applied only if the vehicle is traveling on a road including a slope with a large fluctuation range of the SOC, its application section may be limited. Map information corresponding to a route along which the vehicle is traveling and sensing data obtained from a sensor may be used in parallel to predict an SOC, thus improving the accuracy of power information or fuel consumption. However, a large amount of calculation and time may be consumed in the process of obtaining a dataset for inferring the amount of fuel and the SOC of the battery over time.

### SUMMARY

The present disclosure has been made to solve the above-mentioned problems occurring in the prior art while advantages achieved by the prior art are maintained intact.

An aspect of the present disclosure provides a vehicle control apparatus for controlling a hybrid electric vehicle (HEV), based on an HEV mode or an electric vehicle (EV) mode, and a method thereof.

Another aspect of the present disclosure provides a vehicle control apparatus for dividing a route from a location of a vehicle to a destination into a plurality of sections and controlling the vehicle, using power information corresponding to each of the plurality of sections, and a method thereof.

Another aspect of the present disclosure provides a vehicle control apparatus for predicting power and a speed to minimize fuel consumed while driving the vehicle and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the, a vehicle control apparatus may include an engine, a battery, a processor, and a memory. The processor may predict a change in speed of a vehicle according to a route of the vehicle, may divide the route into a plurality of sections, using the change in speed, may obtain power information of the vehicle, the power information to vary based on the change in speed, in each of the plurality of sections, may determine reference power for maintaining driving of the engine while driving the vehicle in each of the plurality of sections, using the power information corresponding to each of the plurality of sections, and may control the vehicle, based on at least one of an electric vehicle (EV) mode determined according to the reference power or a hybrid electric vehicle (HEV) mode determined according to the reference power, or any combination thereof.

In an embodiment, the processor may identify an average speed of the vehicle according to the change in speed, in each of the plurality of sections, and may obtain the power information with dispersion based on the average speed and an average value obtained using wheel torque of the vehicle.

In an embodiment, the processor may check whether the speed of the vehicle, the speed to vary with the change in speed according to the route, is included within a specified speed range.

In an embodiment, the processor may obtain the power information, using a setting value, if the speed is included outside the specified speed range during a specified time.

In an embodiment, the processor may determine a variance value, using at least one of outside weather, the speed, or grade information associated with the route, or any combination thereof, if the speed is included within the specified speed range during a specified time, and obtain the power information, using the variance value.

In an embodiment, the processor may obtain the power information, using at least one of speed data associated with the route and obtained before driving the vehicle or grade data associated with the route and obtained before driving the vehicle, or any combination thereof.

In an embodiment, the processor may determine a state of charge (SOC) of the battery in a last section among the plurality of sections and may determine the reference power, using the SOC.

In an embodiment, the processor may obtain ratio information for minimizing fuel corresponding to at least one section in which the vehicle is located among the plurality of sections and consumed while the vehicle is traveling along the route, using the reference power and may determine the at least one of the EV mode or the HEV mode, or the any combination thereof in the at least one section, using the ratio information.

In an embodiment, the processor may obtain the ratio information, in a first layer including a dispersion model for obtaining the power information, and may determine the at least one of the EV mode or the HEV mode, or the any combination thereof in the at least one section, using the ratio information, in a second layer including at least one of an acceleration prediction model for controlling the vehicle, a vehicle required power model for controlling the vehicle, or a vehicle control model for controlling the vehicle, or any combination thereof.

In an embodiment, the ratio information may indicate a ratio between a transit time when the vehicle passes through the at least one section and an HEV time when the vehicle is controlled based on the HEV mode in the at least one section.

According to another aspect of the, a vehicle control method may include predicting a change in speed of a vehicle according to a route of the vehicle, dividing the route into a plurality of sections, using the change in speed, obtaining power information of the vehicle, the power information to vary based on the change in speed, in each of the plurality of sections, determining reference power for maintaining driving of an engine while driving the vehicle in each of the plurality of sections, using the power information corresponding to each of the plurality of sections, and controlling the vehicle, based on at least one of an electric vehicle (EV) mode determined according to the reference power or a hybrid electric vehicle (HEV) mode determined according to the reference power, or any combination thereof.

In an embodiment, the obtaining of the power information may include identifying an average speed of the vehicle according to the change in speed, in each of the plurality of sections, and obtaining the power information with dispersion based on the average speed and an average value obtained using wheel torque of the vehicle.

In an embodiment, the obtaining of the power information may include checking whether the speed of the vehicle, the speed to vary with the change in speed according to the route, is included within a specified speed range.

In an embodiment, the checking of whether the speed of the vehicle is included within the specified speed range may include obtaining the power information, using a setting value, if the speed is included outside the specified speed range during a specified time.

In an embodiment, the checking of whether the speed of the vehicle is included within the specified speed range may include determining a variance value, using at least one of outside weather, the speed, or grade information associated with the route, or any combination thereof, if the speed is included within the specified speed range during a specified time; and obtaining the power information, using the variance value.

In an embodiment, the obtaining of the power information may include obtaining the power information, using at least one of speed data associated with the route and obtained before driving the vehicle or grade data associated with the route and obtained before driving the vehicle, or any combination thereof.

In an embodiment, the determining of the reference power may include determining a state of charge (SOC) of a battery in a last section among the plurality of sections and determining the reference power, using the SOC.

In an embodiment, the controlling of the vehicle may include obtaining ratio information for minimizing fuel corresponding to at least one section in which the vehicle is located among the plurality of sections and consumed while the vehicle is traveling along the route, using the reference power, and determining the at least one of the EV mode or the HEV mode, or the any combination thereof in the at least one section, using the ratio information.

In an embodiment, the determining of the at least one of the EV mode or the HEV mode, or the any combination thereof may include obtaining the ratio information, in a first layer including a dispersion model for obtaining the power information, and determining the at least one of the EV mode or the HEV mode, or the any combination thereof in the at least one section, using the ratio information, in a second layer including at least one of an acceleration prediction model for controlling the vehicle, a vehicle required power model for controlling the vehicle, or a vehicle control model for controlling the vehicle, or any combination thereof.

In an embodiment, the ratio information may indicate a ratio between a transit time when the vehicle passes through the at least one section and an HEV time when the vehicle is controlled based on the HEV mode in the at least one section.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example of a block diagram associated with a vehicle control apparatus according to an embodiment of the present disclosure;

FIG. 2 illustrates an example of an operation of selecting a control mode for controlling a vehicle in a vehicle control apparatus according to an embodiment of the present disclosure;

FIG. 3 illustrates an example of a graph illustrating power information used to select a control mode by a vehicle control apparatus according to an embodiment of the present disclosure;

FIG. 4A illustrates an example of an operation of setting reference power for maintaining driving of an engine using obtained power information in a vehicle control apparatus according to an embodiment of the present disclosure;

FIG. 4B illustrates an example of an operation of setting reference power for maintaining driving of an engine using obtained power information in a vehicle control apparatus according to an embodiment of the present disclosure;

FIG. 5 illustrates an example of an operation of setting reference power meeting a constraint of an SOC in a vehicle control apparatus according to an embodiment of the present disclosure;

FIG. 6 illustrates an example of data used to obtain power information by a vehicle control apparatus according to an embodiment of the present disclosure;

FIG. 7 illustrates an example of an exemplary flowchart indicating an operation of a vehicle control apparatus according to an embodiment of the present disclosure;

FIG. 8 illustrates an example of an exemplary flowchart illustrating a vehicle control method according to an embodiment of the present disclosure; and

FIG. 9 illustrates a computing system associated with a vehicle control apparatus or a vehicle control method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The term “module” used in various embodiments of the present disclosure may include a unit implemented with hardware, software, or firmware, and may be interchangeably used with terms, for example, “logic,” “logic block,” “part,” or “circuitry”. A module may be an integral part, or a minimum unit or portion thereof, adapted to perform one or more functions. In an embodiment, the module may be implemented in the form of an application-specific integrated circuit (ASIC). According to various embodiments, operations performed by the module, the program, or another component may be carried out sequentially, in parallel, or repeatedly, or one or more of the operations may be executed in a different order or omitted, or one or more other operations may be added.

Various embodiments of the present disclosure may be implemented as software (e.g., a program) including one or more instructions stored in a storage medium (e.g., an internal memory or an external memory) readable by a machine (e.g., a vehicle control apparatus 100). For example, a processor (e.g., a processor 110) of the device (e.g., the vehicle control apparatus 100) may invoke at least one of the stored one or more instructions from the storage medium and may execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not differentiate between where data is semipermanently stored in the storage medium and where data is temporarily stored in the storage medium.

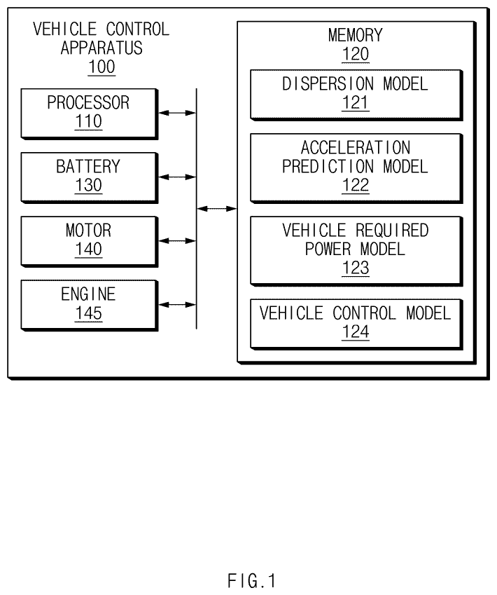

Hereinafter, embodiments of the present disclosure will be described in detail with reference to FIGS. 1 to 9.

FIG. 1 illustrates an example of a block diagram associated with a vehicle control apparatus according to an embodiment of the present disclosure.

Referring to FIG. 1, a vehicle control apparatus 100 according to an embodiment of the present disclosure may be implemented inside or outside a vehicle, and some of the components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include components which are not shown in FIG. 1.

The vehicle associated with the vehicle control apparatus 100 may include a hybrid electric vehicle (HEV). The HEV may include an engine 145, a motor 140, an engine clutch for selectively connecting the engine 145 and the motor 140, a transmission, a differential gear device, a battery, a hybrid starter & generator (HSG) for starting the engine 145 or being generated by the output of the engine 145, and a plurality of wheels. The HSG may be referred to as an integrated starter & generator (ISG). The vehicle control apparatus 100 according to an embodiment may control the vehicle, based on a control mode including an electric vehicle (EV) mode using power of the motor 140, an engine mode using power of the engine 145, an HEV mode for using power of the motor 140 as auxiliary power while using power of the engine 145 as main power, and/or a regenerative braking mode for collecting braking and inertial energy upon braking of the vehicle or driving (or operation) due to inertia through generation of the motor 140 to charge a battery 130.

According to an embodiment, the vehicle control apparatus 100 may include at least one of a processor 110, a memory 120, the battery 130, the motor 140, and the engine 145. The processor 110, the memory 120, the battery 130, the motor 140, and the engine 145 may be electronically or operably coupled to each other by an electrical component, including a communication bus. Hereinafter, that pieces of hardware are operably coupled with each other may mean that a direct connection or an indirect connection between the pieces of hardware is established in a wired or wireless manner, such that second hardware is controlled by first hardware among the pieces of hardware. They are illustrated based on the different blocks, but an embodiment is not limited thereto. Some of the pieces of hardware of FIG. 1 (e.g., at least some of the processor 110, the memory 120, and a communication circuit (not shown)) may be included in a single integrated circuit such as a system on a chip (SoC).

The vehicle control apparatus 100 may further include a hybrid control unit (HCU) for controlling the overall operation of a hybrid electric vehicle (HEV), an engine control unit for controlling an operation of the engine 145, a motor control unit (MCU) for controlling an operation of the motor 140, a transmission control unit for controlling an operation of a transmission, and a battery control unit for controlling and managing the battery 130.

For example, the vehicle control apparatus 100 may control starting of the engine 145 through a hybrid starter generator (HSG) in an idle state of the engine 145 by means of the HCU. The vehicle control apparatus 100 may control control units, such as the MCU connected with a network, such as a controller area network (CAN) which is a vehicle network, in an integrated manner by means of the HCU and may control the overall operation of the HEV. The vehicle control apparatus 100 may control the HSG and the motor 140 by means of the MCU. The vehicle control apparatus 100 may control output torque of the motor 140 depending to a control signal received from the HCU over the network through the MCU to cause the motor 140 to be driven in an area with maximum efficiency. The MCU may include an inverter composed of a plurality of power switching elements. The power switching element constituting the inverter may include at least one of an insulated gate bipolar transistor (IGBT), a metal-oxide-semiconductor field-effect transistor (MOSFET), a field-effect transistor (FET), a transistor (TR), or a relay. The inverter may be used to convert a DC voltage supplied from the battery 130 into a 3-phase AC voltage to drive the motor 140.

The processor 110 of the vehicle control apparatus 100 according to an embodiment may include a hardware component for processing data based on one or more instructions. The hardware component for processing the data may include, for example, an arithmetic and logic unit (ALU), a floating point unit (FPU), a field programmable gate array (FPGA), a central processing unit (CPU), a micro controlling unit (MCU), and/or an application processor (AP). The number of the processors 110 may be one or more in number. For example, the processor 110 may have a structure of a multi-core processor including a dual core, a quad core, a hexa core, or an octa core.

The memory 120 of the vehicle control apparatus 100 according to embodiment may include a hardware component for storing data and/or instructions input and/or output from the processor 110. The memory 120 may include, for example, a volatile memory, such as a random-access memory (RAM), and/or a non-volatile memory, such as a read-only memory (ROM). For example, the volatile memory may include at least one of a dynamic RAM (DRAM), a static RAM (SRAM), a cache RAM, or a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disc, or an embedded multi-media card (eMMC).

The battery 130 of the vehicle control apparatus 100 may include a battery cell, a battery module, or a battery pack. For example, the battery 130 may be composed of one or more unit cells. The battery 130 may include a capacitor or a secondary battery, which stores power depending on charging. For example, the battery 130 may include any one of a lithium (Li)-ion battery, a Li-ion polymer battery, a lead-acid battery, a nickel-cadmium (NiCd) battery, or a nickel-metal hydride (NiMH) battery. The battery 130 may supply electricity to the motor 140 in the EV mode and the HEV mode and may be charged through electricity collected through the motor 140 in the regenerative braking mode.

The motor 140 of the vehicle control apparatus 100 may operate depending on a 3-phase AC voltage output from the MCU to generate torque. For example, the motor 140 may supply regenerative energy to the battery 130, based on coasting drive or regenerative braking.

The vehicle control apparatus 100 may receive map information (or navigation information) from the external server through the communication circuit. The map information may include information about a grade degree of a road included in three-dimensional (3D) map data, information about a speed limit, and/or information about a traffic speed included in transport protocol expert group (TPEG) data.

The vehicle control apparatus 100 according to embodiment may further include a sensor. The sensor may generate electronic information capable of being processed by the processor 110 and/or the memory 120 of the vehicle control apparatus 100, from non-electronic information associated with the vehicle control apparatus 100. In an embodiment, the sensor may include one or more sensors. For example, the sensors may be attached to different positions of the vehicle. The sensors may face one or more different directions. For example, the sensors may be attached to the front, sides, rear, or roof of the vehicle to face directions, such as forward-facing, rear-facing, and side-facing.

In an embodiment, the sensors may be image sensors such as high dynamic range cameras. For example, the sensors may include non-visual sensors. For example, the sensors may include radio detection and ranging (RADAR), light detection and ranging (LiDAR), and/or an ultrasonic sensor, other than the image sensor.

For example, the vehicle control apparatus 100 may obtain sensing data for moving object posture information, moving object collision information, moving object direction information, moving object position information (or GPS information), moving object angle information, moving object speed information, moving object acceleration information, moving object tilt information, moving object forward/backward information, battery information, fuel information, tire information, moving object lamp information, moving object internal temperature information, moving object internal humidity information, a steering wheel rotation angle, moving object external illumination, pressure applied to the accelerator pedal, and/or pressure applied to the brake pedal, by means of the sensor. However, the present disclosure is not limited thereto.

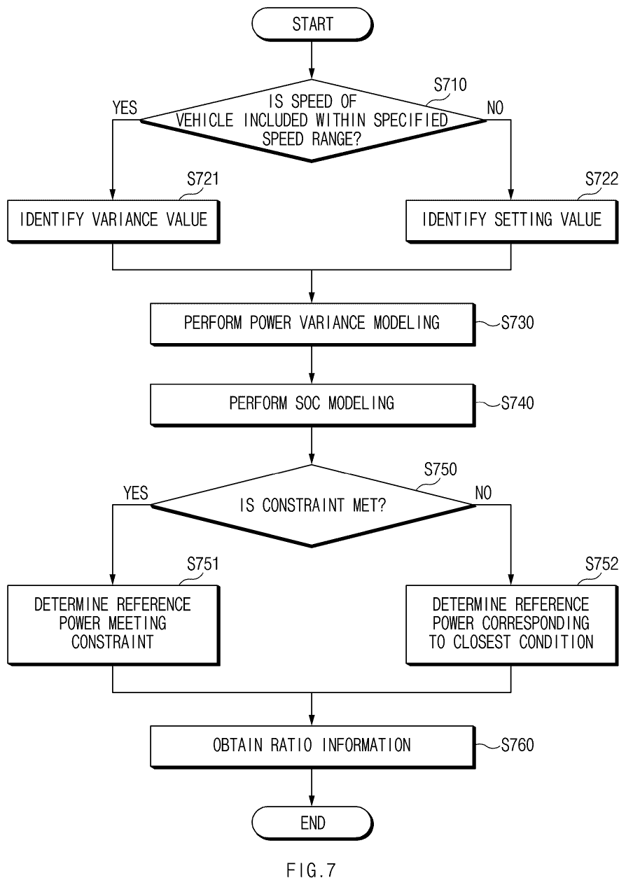

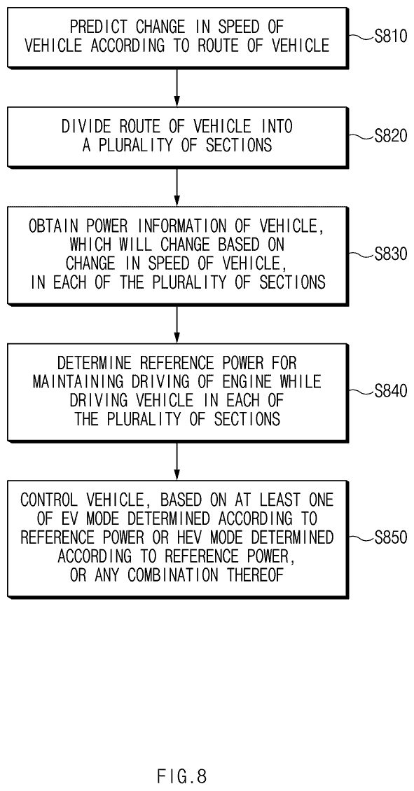

One or more instructions indicating calculation and/or an operation to be performed for data by the processor 110 of the vehicle control apparatus 100 may be stored in the memory 120 of the vehicle control apparatus 100 according to an embodiment. A set of the one or more instructions may be referred to as firmware, an operating system, a process, a routine, a sub-routine, and/or an application. For example, if a set of a plurality of instructions distributed in the form of an operating system, firmware, a driver, and/or an application is executed, the vehicle control apparatus 100 and/or the processor 110 may perform at least one of the operations of FIGS. 7 and 8.

The vehicle control apparatus 100 according to embodiment may include a dispersion model 121, an acceleration prediction model 122, a vehicle required power model 123, and/or a vehicle control model 124, which are/is represented by a set of parameters stored in the memory 120. The number of the models stored in the memory 120 may not be limited to that shown in FIG. 1.

In an embodiment, the vehicle control apparatus 100 may predict a change in speed of the vehicle according to a route of the vehicle, using the map information (or the navigation information) received through the communication circuit 150, by means of the dispersion model 121. The vehicle control apparatus 100 may divide the route of the vehicle into a plurality of sections, using the change in speed of the vehicle. As an example, the vehicle control apparatus 100 may divide the route of the vehicle into the plurality of sections, using grade information.

The vehicle control apparatus 100 may obtain power information of the vehicle, which will vary based on the change in speed in each of the plurality of sections.

The vehicle control apparatus 100 according to an embodiment may identify an average speed of the vehicle according to the change in speed, in each of the plurality of sections. For example, the vehicle control apparatus 100 may obtain power information with dispersion based on the average speed and an average value obtained using wheel torque of the vehicle.

The vehicle control apparatus 100 may check whether the speed of the vehicle, which will vary with the change in speed according to the route, is included within a specified speed range.

For example, if the speed is included outside the specified speed range during a specified time, the vehicle control apparatus 100 may obtain power information, using a setting value.

As an example, the setting value may be determined according to speed data and/or grade data, which are/is accumulated while the vehicle is traveling. The setting value may indicate a variance value which is initially set.

For example, if the speed of the vehicle is included within the specified speed range during the specified time, the vehicle control apparatus 100 may determine a variance value, using at least one of outside weather, the speed, or grade information associated with the route, or any combination thereof. For example, the vehicle control apparatus 100 may obtain power information, using the variance value.

The vehicle control apparatus 100 may determine reference power for maintaining driving of the engine 145 while the vehicle is traveling in each of the plurality of sections using power information corresponding to each of the plurality of sections.

The vehicle control apparatus 100 may control the vehicle based on at least one of the EV mode determined according to the reference power or the HEV mode determined according to the reference power, or any combination thereof.

The vehicle control apparatus 100 may determine a state of charge (SOC) of the battery 130 in a last section among the plurality of sections. For example, the vehicle control apparatus 100 may determine the reference power, using the determined SOC.

For example, the vehicle control apparatus 100 may obtain SOC information of the battery 130, which will vary based on the change in speed of the vehicle. The vehicle control apparatus 100 may obtain ratio information between a transit time when the vehicle passes through each of the plurality of sections and an HEV time for controlling the vehicle based on the HEV mode in each of the plurality of sections, using the SOC information of the battery 130.

For example, the ratio information may indicate a ratio between a transit time when the vehicle passes through at least one section and an HEV time for controlling the vehicle based on the HEV mode in the at least one section.

For example, the vehicle control apparatus 100 may obtain ratio information for minimizing fuel which corresponds to at least one section in which the vehicle is located among the plurality of sections and is consumed while the vehicle is traveling along the route, using the reference power. For example, the vehicle control apparatus 100 may determine at least one of the EV mode or the HEV mode, or any combination thereof in the at least one section, using the ratio information.

In an embodiment, the vehicle control apparatus 100 may identify (or predict) acceleration of the vehicle in the at least one section in which the vehicle is located among the plurality of sections, using sensing data (or sensor information) obtained from the sensor, by means of the acceleration prediction model 122. For example, the sensing data may include at least one of a relative position between the vehicle including the vehicle control apparatus 100 and another vehicle and/or a relative speed of the other vehicle with respect to the vehicle.

In an embodiment, the vehicle control apparatus 100 may predict power necessary to obtain the identified acceleration, by means of the vehicle required power model 123. The vehicle control apparatus 100 may predict a speed of the vehicle, which will be obtained based on the identified acceleration, by means of the vehicle required power model 123. The vehicle control apparatus 100 may obtain fuel consumption information, using at least one of power information indicating the predicted power, speed information indicating the predicted speed of the vehicle, or the ratio information, or any combination thereof. The fuel consumption information may include information for minimizing fuel consumed while the vehicle is driving along the route. The vehicle control apparatus 100 may control the vehicle along the route to minimize fuel to be consumed, based on the EV mode or the HEV mode, using the obtained fuel consumption information.

The vehicle control apparatus 100 may control the vehicle. For example, the vehicle control apparatus 100 may adjust steering and/or a speed of the vehicle. For example, the vehicle control apparatus 100 may perform deceleration, acceleration, steering, lane change, and/or lane keeping to control driving of the vehicle. For example, the vehicle control apparatus 100 may generate control signals for controlling vehicle lighting including at least one of brake lights, turn signals, and/or headlights. In some embodiments, the vehicle control apparatus 100 may control audio-related systems including a vehicle's sound system, vehicle's audio warnings, a vehicle's microphone system, and/or a vehicle's horn system.

The vehicle control apparatus 100 may control the vehicle based on an autonomous driving mode. The autonomous driving mode of the vehicle may include a driver assistance function (e.g., an advanced driver assistance system (ADAS)) of the vehicle. The autonomous driving mode of the vehicle may include adaptive cruise control (ACC) and/or smart cruise control (SCC). However, it is not limited thereto.

The vehicle control apparatus 100 may identify an input indicating execution of the autonomous driving mode. The vehicle control apparatus 100 may control the vehicle on which the vehicle control apparatus 100 is mounted, based on the autonomous driving mode. The vehicle may be driven by the vehicle control apparatus 100, based on the autonomous driving mode.

As described above, the vehicle control apparatus 100 according to an embodiment may predict required power for each section for the plurality of sections, based on a model prediction control optimization technique. The vehicle control apparatus 100 may perform power distribution for controlling the vehicle, using the predicted required power. The vehicle control apparatus 100 may improve fuel efficiency for controlling the vehicle, using long-distance prediction information (e.g., global information), such as map information, and near-future prediction information (e.g., local information), such as sensing data. Furthermore, the vehicle control apparatus 100 may predict an Soc progress for each section in each of the plurality of sections, thus improving fuel efficiency for controlling the vehicle on a flat road, as well as a road including a hill.

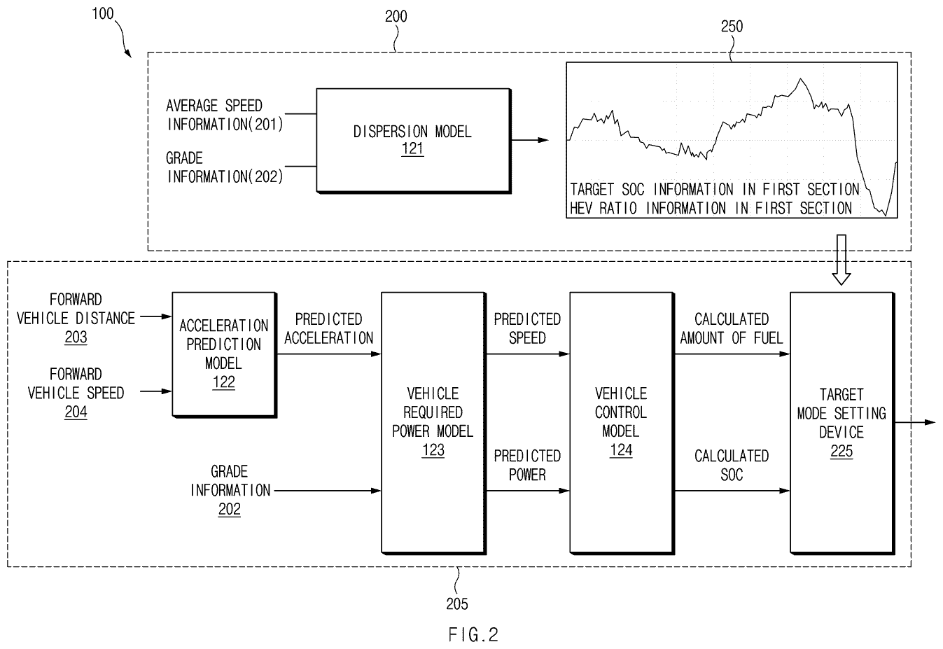

FIG. 2 illustrates an example of an operation of selecting a control mode for controlling a vehicle in a vehicle control apparatus according to an embodiment of the present disclosure. A vehicle control apparatus 100 of FIG. 2 may be referred to a vehicle control apparatus 100 of FIG. 1.

The vehicle control apparatus 100 according to embodiment may perform operations divided into a plurality of layers to set a control mode for controlling a vehicle.

In an embodiment, a first layer 200 may be referred to as an upper layer, in terms of obtaining ratio information 250, before the vehicle control apparatus 100 controls the vehicle. The operation performed in the first layer 200 by the vehicle control apparatus 100 may be associated with global path planning, in terms of using map information (e.g., average speed information 201 or grade information 202). The first layer 200 may include a dispersion model 121.

In an embodiment, a second layer 205 may be referred to as a lower layer, in terms of using the ratio information 250 obtained in the first layer 200. The operation performed in the second layer 205 by the vehicle control apparatus 100 may be associated with local path planning, in terms of using sensor information (e.g., a forward vehicle distance 203 or a forward vehicle speed 204). The operation performed through the first layer 200 by the vehicle control apparatus 100 and the operation performed through the second layer 205 by the vehicle control apparatus 100 may be performed in parallel.

The vehicle control apparatus 100 according to embodiment may obtain the ratio information 250, in the first layer 200 including the dispersion model 121 for obtaining power information.

For example, the vehicle control apparatus 100 may obtain power information by means of the dispersion model 121 to which the average speed information 201 corresponding to a route of the vehicle and/or the grade information 202 are input.

For example, the vehicle control apparatus 100 may obtain the ratio information 250 for driving the vehicle based on an HEV mode in at least one section in which the vehicle is located among a plurality of sections, using the obtained power information.

The vehicle control apparatus 100 may determine at least one of an EV mode or the HEV mode, or any combination thereof in the at least one section in which the vehicle is located, using the ratio information 250, in the second layer 205 including at least one of an acceleration prediction model 122 for controlling the vehicle, a vehicle required power model 123 for controlling the vehicle, or a vehicle control model 124 for controlling the vehicle, or any combination thereof.

For example, in the second layer 205, the vehicle control apparatus 100 according to an embodiment may predict acceleration, by means of the acceleration prediction model 122 to which the sensor information is input. The sensor information may include at least one of the forward vehicle distance 203 indicating a relative location between the vehicle including the vehicle control apparatus 100 and another vehicle (e.g., a forward vehicle) and/or the forward vehicle speed 204 indicating a relative speed of the other vehicle with respect to the vehicle.

The vehicle control apparatus 100 may predict power necessary to obtain a speed and acceleration of the vehicle, which will be obtained based on the predicted acceleration, by means of the vehicle required power model 123, using the acceleration. For example, the vehicle control apparatus 100 may predict power and a speed, using the grade information 202. However, it is not limited thereto.

The vehicle control apparatus 100 may obtain fuel consumption information, using at least one of predicted power information indicating the predicted power, predicted speed information indicating a speed of the vehicle, or the ratio information 250 obtained in the first layer 200, or any combination thereof, by means of the vehicle required power model 123.

In an embodiment, the fuel consumption information may include an amount of fuel to be consumed if driving the vehicle based on a first mode (e.g., the HEV mode) and an amount of fuel to be consumed if driving the vehicle based on a second mode (e.g., the EV mode). The vehicle control model 124 may include vehicle control models (e.g., an EV control mode or an HEV control model) capable of controlling the vehicle based on the first mode or the second mode.

In an embodiment, the vehicle control apparatus 100 may predict an amount of energy to be consumed when controlling the vehicle along at least a portion of the route based on the first mode (e.g., the HEV mode) or the second mode (e.g., the EV mode), by means of the vehicle control model 124. The amount of energy may include information about an SOC of a battery. The vehicle control apparatus 100 may obtain an amount of energy including SOC information indicating an SOC of the battery, which will vary depending on controlling the vehicle based on the control mode.

The vehicle control apparatus 100 according to an embodiment may obtain fuel consumption information for minimizing fuel to be consumed if driving the vehicle along the route, using the amount of energy.

The vehicle control apparatus 100 may determine a control mode for controlling the vehicle in the at least one section in which the vehicle is located among the plurality of sections, based on execution of a target mode setting device 225, using the fuel consumption information and/or the ratio information 250. For example, the vehicle control apparatus 100 may control the vehicle based on the determined control mode (e.g., the EV mode or the HEV mode).

As described above, the vehicle control apparatus 100 according to an embodiment may minimize fuel consumption, while controlling the vehicle along the route, using the first layer 200 for obtaining the ratio information 250 and the second layer 205 for selecting the control mode for selecting the vehicle. The vehicle control apparatus 100 may obtain the ratio information 250, using macro information (e.g., map information) between the route and the vehicle, in the first layer 200, and may obtain fuel consumption information, using micro-information (e.g., sensor information) between the vehicle and a forward vehicle, in the second layer 205. The vehicle control apparatus 100 may use the macro information and the micro-information in an integrated manner, thus optimizing an SOC operation strategy.

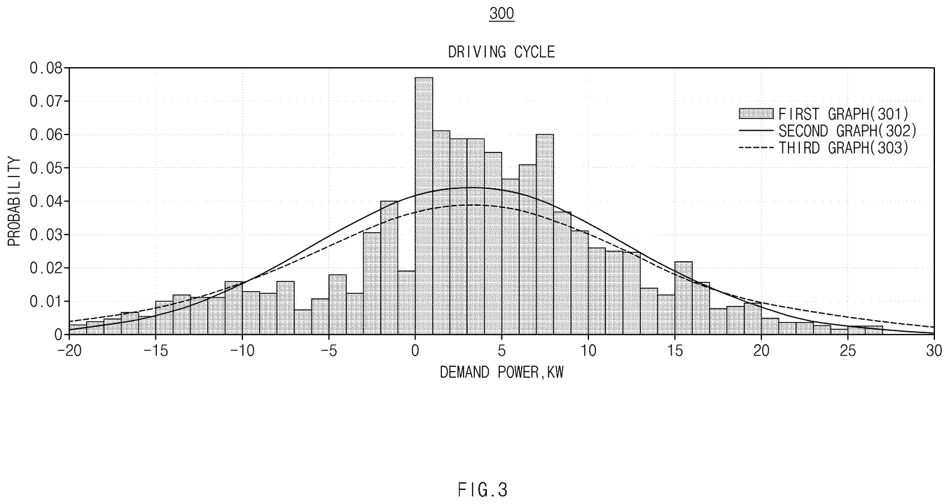

FIG. 3 illustrates an example of a graph illustrating power information used to select a control mode by a vehicle control apparatus according to an embodiment of the present disclosure.

Referring to FIG. 3, an example of a graph 300 illustrating load dispersion obtained while driving a vehicle by the vehicle control apparatus according to embodiment is illustrated. The graph 300 may include information about power identified by a vehicle control apparatus 100 during one driving cycle. The driving cycle may include a time interval from a time point when the driving of the vehicle is initiated (or when the vehicle is ignition on) to a time point when the driving of the vehicle is completed (or when the vehicle is ignition off).

In an embodiment, the graph 300 may include a first graph 301 in which power information obtained before driving the vehicle by the vehicle control apparatus 100 is accumulated, a second graph 302 illustrating the standard normal distribution for the information included in the first graph 301, and/or a third graph 303 obtained by performing the trigonometric convert of the information included in the first graph 301.

In an embodiment, the vehicle control apparatus 100 may obtain power information represented as at least one of the first graph 301, the second graph 302, or the third graph 303.

For example, a driving characteristic for controlling the vehicle may be reflected in the power information. For example, because the vehicle control apparatus 100 performs acceleration or deceleration depending on a grade degree included in a route, the driving characteristic for controlling the vehicle may be reflected in the power information.

For example, the power information may have dispersion corresponding to a specified variance value based on an average value. As an example, the average value may be obtained using a speed of the vehicle and wheel torque of the vehicle.

As described above, the vehicle control apparatus 100 may improve the accuracy of the ratio information by using the power information in which the driving characteristic of the vehicle which drives on a real road is reflected.

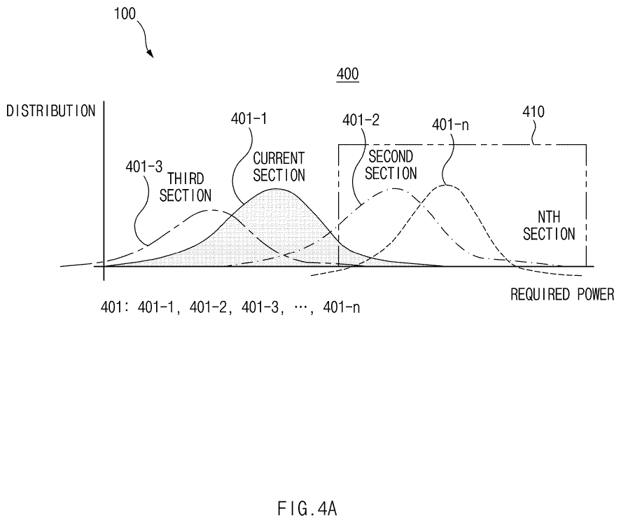

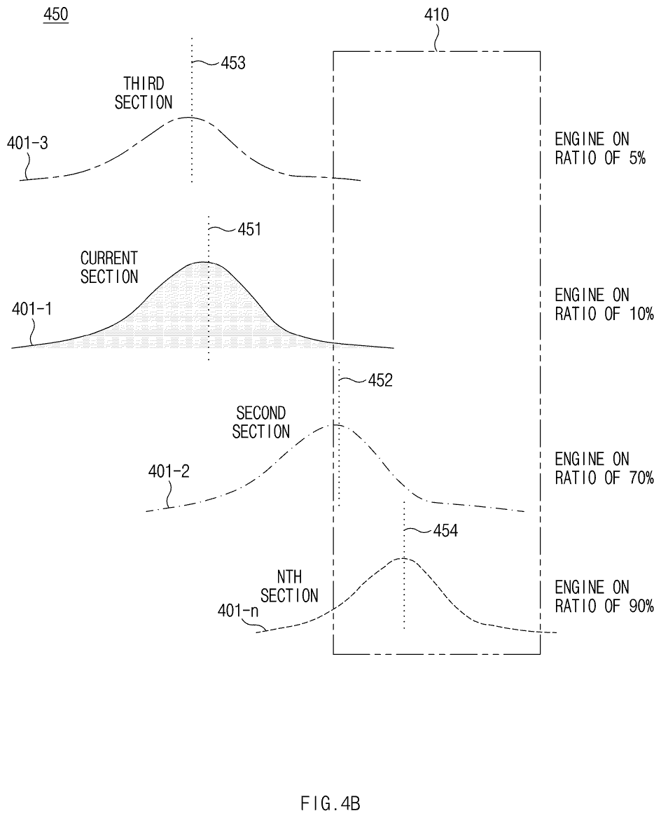

FIGS. 4A and 4B illustrate an example of an operation of setting reference power for maintaining driving of an engine using obtained power information in a vehicle control apparatus, according to an embodiment of the present disclosure. A vehicle control apparatus 100 of FIG. 4A or 4B may be referred to a vehicle control apparatus 100 of FIG. 1.

Referring to FIG. 4A, in an example 400, the vehicle control apparatus 100 may identify a route of a vehicle using map information. The route of the vehicle may indicate a specified route from a current location of the vehicle to a destination of the vehicle.

For example, the vehicle control apparatus 100 may predict a change in speed of the vehicle according to the route of the vehicle. For example, the vehicle control apparatus 100 may divide the route into a plurality of sections using the change in speed and/or grade information associated with the route.

For example, the vehicle control apparatus 100 may obtain power information 401 of the vehicle, which will vary based on the change in speed in each of the plurality of sections. The power information 401 may be represented as a third graph 303 of FIG. 3. The operation in which the vehicle control apparatus 100 obtains the power information 401 may be referred to as a power variance modeling operation.

For example, the vehicle control apparatus 100 may obtain the power information 401 corresponding to each of the plurality of sections. For example, the power information 401 may include first sub-power information 401-1 corresponding to a current section including the current location of the vehicle, second sub-power information 401-2 corresponding to a second section 401-2 adjacent to the current section, third sub-power information 401-3 corresponding to a third section 401-3 arranged subsequent to the second section 401-2, and nth sub-power information 401-n corresponding to an nth section.

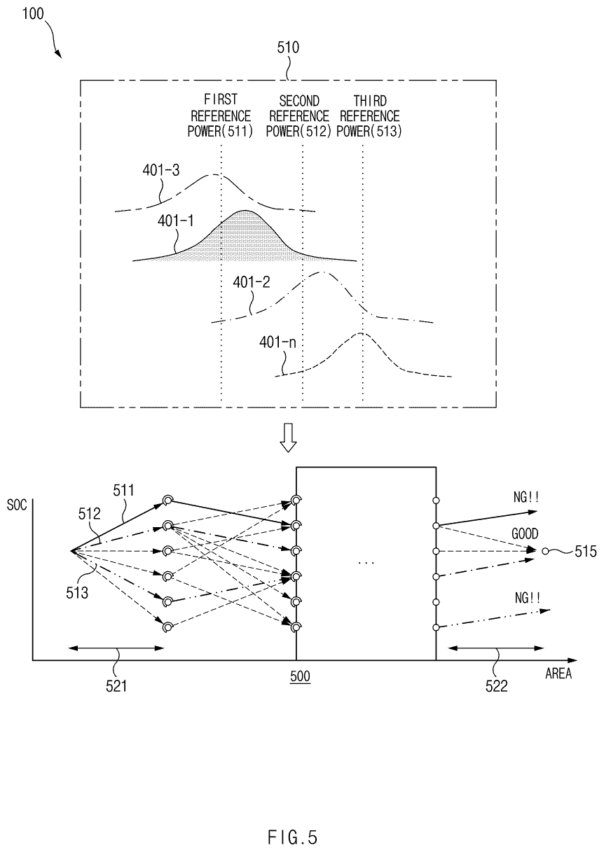

Referring to FIG. 4B, in an example 450, the vehicle control apparatus 100 may set an engine running area 410 for maintaining driving of an engine, based on obtaining the power information 401. The engine running area 410 may be set according to reference power for initiating the driving of the engine. For example, the operation in which the vehicle control apparatus 100 obtains the reference power will be described in detail below with reference to FIG. 5.

For example, the vehicle control apparatus 100 may obtain the first sub-power information 401-1 corresponding to the current section including the current location of the vehicle, the second sub-power information 401-2 corresponding to the second section adjacent to the current section, the third sub-power information 401-3 corresponding to the third section arranged subsequent to the second section, and the nth sub-power information 401-n corresponding to the nth section.

In an embodiment, the first sub-power information 401-1, the second sub-power information 401-2, the third sub-power information 401-3, and/or the nth sub-power information 401-n may be obtained based on different average values. The first sub-power information 401-1, the second sub-power information 401-2, the third sub-power information 401-3, and/or the nth sub-power information 401-n may have the same variance value or different variance values.

In an embodiment, the first sub-power information 401-1 may have dispersion corresponding to a first variance value based on a first average value 451. The second sub-power information 401-2 may have dispersion corresponding to a second variance value based on a second average value 452. The third sub-power information 401-3 may have dispersion corresponding to a third variance value based on a third average value 453. The nth sub-power information 401-n may have dispersion corresponding to an nth variance value based on an nth average value 454. However, it is not limited thereto.

In an embodiment, the vehicle control apparatus 100 may obtain the engine running area 410 for maintaining the driving of the engine. For example, the vehicle control apparatus 100 may maintain the driving of the engine, in an area where the power information 401 and the engine running area 410 are mapped to each other. For example, the vehicle control apparatus 100 may control the vehicle based on an HEV mode in a partial area where the power information 401 and the engine running area 410 are mapped to each other.

In the example 450, the ratio at which the engine is driven may indicate an engine driving time for a time obtained by adding an engine driving time and a battery driving time in each of the plurality of sections. For example, the ratio at which the engine is driven in the first section corresponding to the first sub-power information 401-1 may be a first value (e.g., 10%). In other words, while driving the vehicle along the first section, the vehicle control apparatus 100 may control the vehicle based on the HEV mode depending on the ratio and may control the vehicle based on an EV mode depending on another ratio.

FIG. 5 illustrates an example of an operation of setting reference power meeting a constraint of an SOC in a vehicle control apparatus, according to an embodiment of the present disclosure. Referring to FIG. 5, a vehicle control apparatus 100 may be referred to a vehicle control apparatus 100 of FIG. 1.

Referring to FIG. 5, in an example 510, the vehicle control apparatus 100 may adjust reference power for setting an engine running area (e.g., an engine running area 410 of FIG. 4A). The reference power may indicate a start location of the engine running area.

The vehicle control apparatus 100 may determine the reference power depending on an SOC of a battery, based on obtaining a ratio at which the engine is driven in each of a plurality of sections.

For example, the ratio at which the engine is driven in each of the plurality of sections may vary with the reference power. As an example, a first ratio at which the engine is driven, which is identified based on setting the engine running area based on first reference power 511, in all of the plurality of sections, may be relatively greater than a second ratio at which the engine is driven, which is identified based on setting the engine running area based on second reference power 512.

In an example 500, the vehicle control apparatus 100 may determine an SOC 515 of the battery in a last section 522 among the plurality of sections. The SOC of the battery may include a specified range (e.g., 50% to 60%). The vehicle control apparatus 100 may determine reference power, using the SOC.

The vehicle control apparatus 100 may adjust the reference power, such that the SOC of the battery, which will be identified after controlling the vehicle, has a specified value (e.g., the SOC 515). For example, if setting the engine running area based on the first reference power 511 (or third reference power 513), the vehicle control apparatus 100 may predict an SOC different from the SOC 515 of the battery in the last section 522. Because of predicting the different soc, the vehicle control apparatus 100 may refrain from setting the engine running area based on the first reference power 511 (or the third reference power 513). In other words, the vehicle control apparatus 100 according to embodiment may set the engine running area based on the second reference power 512 at which the SOC 515 of the battery is predicted. For example, the vehicle control apparatus 100 may obtain ratio information about at least one section 521 in which the vehicle is located among the plurality of sections, using the set engine running area. The vehicle control apparatus 100 may determine a control mode for controlling the vehicle in the at least one section 521 using the ratio information.

For example, the vehicle control apparatus 100 may identify reference power for obtaining the SOC 515, based on a gradient descent method. For example, the operation in which the vehicle control apparatus 100 determines the reference power to obtain (or follow) the specified value (e.g., the SOC 515) may be referred to as an SOC modeling operation.

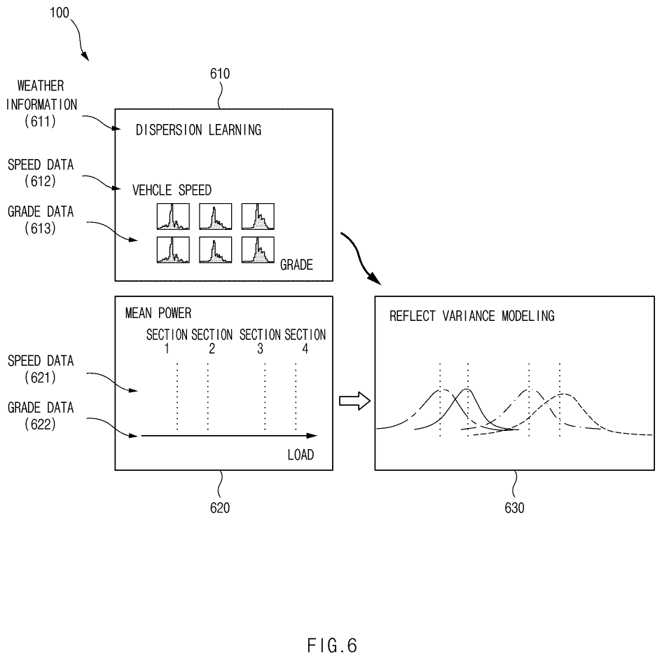

FIG. 6 illustrates an example of data used to obtain power information by a vehicle control apparatus according to an embodiment of the present disclosure. A vehicle control apparatus 100 of FIG. 6 may be referred to a vehicle control apparatus 100 of FIG. 1.

Referring to FIG. 6, an example of an operation of obtaining power information 630 by means of a dispersion model (e.g., a dispersion model 121 of FIG. 1) in the vehicle control apparatus 100 according to an embodiment is illustrated.

The vehicle control apparatus 100 according to embodiment may obtain power information, using at least one of speed data 612 associated with a route and obtained before driving a vehicle or grade data 613 associated with the route and obtained before driving the vehicle, or any combination thereof. For example, the vehicle control apparatus 100 may perform dispersion learning using weather information 611 and/or the speed data 612 and the grade data 613.

For example, the weather information 611 may include an outside air temperature and/or an intake air temperature.

For example, the speed data 612 and/or the grade data 613 may include data accumulated in the past. The data accumulated in the past may include datasets obtained before driving the vehicle by the vehicle control apparatus 100.

In an embodiment, the vehicle control apparatus 100 may obtain a variance characteristic according to a speed of a vehicle and/or a grade degree using the weather information 611 and/or the speed data 612 and the grade data 613. For example, the vehicle control apparatus 100 may obtain a variance value indicating a degree to which values of datasets are distributed using the weather information 611 and/or the speed data 612 and the grade data 613.

The vehicle control apparatus 100 may identify an average value indicating an average speed of the vehicle in each of the plurality of sections, using the speed data 621 and/or the grade data 622. The average value may include a value in which a load characteristic is reflected.

For example, the speed data 621 may indicate a speed of the vehicle, which will be predicted while the vehicle is traveling along the route. The grade data 622 may include grade information associated with the route. The speed data 621 may be referred to as future speed data in terms of indicating the speed of the vehicle, which will be predicted. The grade data 622 may be referred to as future grade data in terms of indicating grade information to be identified while the vehicle is traveling along the route.

The vehicle control apparatus 100 may obtain power information 630 corresponding to each of the plurality of sections, based on the variance value identified through dispersion learning and the average value. The power information 630 may be referred to power information 401 of FIG. 4A.

FIG. 7 illustrates an example of an exemplary flowchart indicating an operation of a vehicle control apparatus according to an embodiment of the present disclosure. Hereinafter, it is assumed that a vehicle control apparatus 100 of FIG. 1 performs a process of FIG. 7. Furthermore, in a description of FIG. 7, an operation described as being performed by a vehicle control apparatus may be understood as being controlled by a processor 110 of the vehicle control apparatus 100. The respective operations of FIG. 7 may be sequentially performed, but are not necessarily sequentially performed. For example, an order of the respective operations may be changed, and at least two operations may be performed in parallel.

Referring to FIG. 7, in S710, the vehicle control apparatus according to an embodiment may check whether a speed of a vehicle is included within a specified speed range.

For example, if the speed of the vehicle is included within the specified speed range during a specified time (e.g., about 30 seconds), the vehicle control apparatus may use the speed of the vehicle as data for identifying a variance value.

For example, the specified speed range may have a range from a first speed (e.g., 20 kph) to a second speed (e.g., 40 kph). However, it is not limited thereto. As an example, the vehicle control apparatus may change the first speed and the second speed.

Referring to FIG. 7, if the speed of the vehicle is out of the specified speed range (S710—NO), in S722, the vehicle control apparatus according to embodiment may identify a setting value for obtaining power information with dispersion. For example, the vehicle control apparatus may identify the setting value using data included in a graph 300 of FIG. 3.

Referring to FIG. 7, if the speed of the vehicle is included within the specified speed range (S710—YES), in S721, the vehicle control apparatus according to embodiment may identify a variance value for obtaining power information with dispersion. For example, the vehicle control apparatus may identify a variance value mapped to weather, an outside air temperature, an intake air temperature, a speed of the vehicle, and/or grade information.

Referring to FIG. 7, after performing at least one of S721 or S722, in S730, the vehicle control apparatus according to embodiment may perform power variance modeling.

For example, the vehicle control apparatus may receive map information via a communication circuit from an external server. The vehicle control apparatus may set a route along which the vehicle will move, based on receiving the map information. The vehicle control apparatus may divide the route into a plurality of sections, depending on speed information and/or grade information according to the route. The vehicle control apparatus may obtain power information corresponding to each of the plurality of sections. An example of the operation of obtaining the power information may be referred to an example 400 of FIG. 4A.

Referring to FIG. 7, in S740, the vehicle control apparatus according to an embodiment may perform SOC modeling.

In an embodiment, the vehicle control apparatus may set an engine running area (e.g., an engine running area 410 of FIG. 4A), based on performing the SOC modeling. For example, the vehicle control apparatus may set an SOC to be identified in a last section among the plurality of sections. The vehicle control apparatus may adjust reference power to identify the SOC in the last section among the plurality of sections. The vehicle control apparatus may adjust the reference power to obtain a starting point of the engine running area in each of the plurality of sections.

Referring to FIG. 7, in S750, the vehicle control apparatus according to an embodiment may adjust the reference power to check whether the reference power meets a constraint. For example, the constraint may indicate whether an SOC is identified in the last section among the plurality of sections by setting the reference power.

Referring to FIG. 7, if the set reference power meets the constraint (S750—YES), in S751, the vehicle control apparatus according to embodiment may determine the reference power meeting the constraint.

Referring to FIG. 7, in S760, the vehicle control apparatus according to embodiment may determine the reference power to obtain ratio information for driving the vehicle based on an HEV mode. The ratio information may include ratio information about at least one section in which the vehicle is located among the plurality of sections.

Referring to FIG. 7, if the set reference power does not meet the constraint (S750—NO), in S752, the vehicle control apparatus according to embodiment may determine the reference power meeting a condition closest to the constraint.

For example, if the SOC corresponding to the constraint is a first SOC (e.g., about 50%), the vehicle control apparatus may adjust reference power to identify a second SOC (e.g., about 40%) and/or a third SOC (e.g., about 20%), which are/is different from the first SOC. For example, if the vehicle control apparatus is unable to identify the first SOC although adjusting the reference power, it may determine reference power for obtaining the second SOC relatively close to the first SOC among other SOCs differentiating from the first SOC. However, it is not limited thereto. For example, in S760, the vehicle control apparatus may obtain ratio information for driving the vehicle based on the HEV mode, using the determined reference power.

As described above, the vehicle control apparatus may determine the Soc to be identified in the last section among the plurality of sections, without the necessity of setting a strategy for driving the vehicle in each of the plurality of sections, to determine the reference power. Because there is no the need to set the strategy for driving the vehicle in each of the plurality of sections, the vehicle control apparatus may reduce an amount of calculation for determining an engine running area corresponding to each of the plurality of sections.

FIG. 8 illustrates an example of an exemplary flowchart illustrating a vehicle control method according to an embodiment of the present disclosure. Hereinafter, it is assumed that a vehicle control apparatus 100 of FIG. 1 performs a process of FIG. 8. Furthermore, in a description of FIG. 8, an operation described as being performed by an apparatus may be understood as being controlled by a processor 110 of the vehicle control apparatus 100. The respective operations of FIG. 8 may be sequentially performed, but are not necessarily sequentially performed. For example, an order of the respective operations may be changed, and at least two operations may be performed in parallel.

Referring to FIG. 8, in S810, the vehicle control method may include predicting a change in speed of a vehicle according to a route of the vehicle. The vehicle control method may include predicting the change in speed of the vehicle, using map information according to the route. The map information may include speed information and/or grade information according to the route.

Referring to FIG. 8, in S820, the vehicle control method may include dividing the route of the vehicle into a plurality of sections. The vehicle control method may include dividing the route of the vehicle into the plurality of sections using the map information. The vehicle control method may include dividing the route into the plurality of sections depending on a point at which a speed limit changes. The vehicle control method may include dividing the route into the plurality of sections depending on a point at which a grade degree changes. However, it is not limited thereto.

Referring to FIG. 8, in S830, the vehicle control method may include obtaining power information of the vehicle, which will vary based on the change in speed of the vehicle, in each of the plurality of sections.

The vehicle control method may include identifying an average speed of the vehicle according to the change in speed, in each of the plurality of sections. The vehicle control method may include obtaining power information with dispersion based on the average speed and an average value obtained using wheel torque of the vehicle.

For example, an example of the operation of obtaining the power information of the vehicle may be referred to an example 400 of FIG. 4A.

Referring to FIG. 8, in S840, the vehicle control method may include determining reference power for maintaining driving of an engine while driving the vehicle in each of the plurality of sections.

The vehicle control method may include checking whether a speed of the vehicle, which will vary with the change in speed according to the route, is included within a specified speed range.

For example, the vehicle control method may include obtaining power information, using a setting value, if the speed is included outside the specified speed range during a specified time.

For example, the vehicle control method may include determining a variance value, using at least one of outside weather, the speed, or grade information associated with the route, or any combination thereof, if the speed is included within the specified speed range during the specified time. For example, the vehicle control method may include obtaining power information using the variance value.

For example, the vehicle control method may include determining an SOC of a battery in a last section among the plurality of sections. The vehicle control method may include determining reference power using the determined SOC.

For example, determining the reference power may be referred to at least one of S740 of FIGS. 7 and S750 to S752 of FIG. 7.

Referring to FIG. 8, in S850, the vehicle control method may include controlling the vehicle, based on at least one of an EV mode determined according to the reference power or an HEV mode determined according to the reference power, or any combination thereof.

For example, the vehicle control method may include obtaining ratio information for minimizing fuel which corresponds to at least one section in which the vehicle is located among the plurality of sections and is consumed while the vehicle is traveling along the route, using the reference power.

For example, the vehicle control method may include determining at least one of the EV mode or the HEV mode, or any combination thereof in the at least one section, using the ratio information.

In an embodiment, the vehicle control method may include obtaining ratio information, in a first layer including a dispersion model for obtaining power information. For example, the vehicle control method according t to embodiment may include determining at least one of the EV mode or the HEV mode, or any combination thereof in the at least one section, using the ratio information, in a second layer including at least one of an acceleration prediction model for controlling the vehicle, a vehicle required power model for controlling the vehicle, or a vehicle control model for controlling the vehicle, or any combination thereof. For example, the ratio information may indicate a ratio between a transit time when the vehicle passes through the at least one section and an HEV time for controlling the vehicle based on the HEV mode in the at least one section.

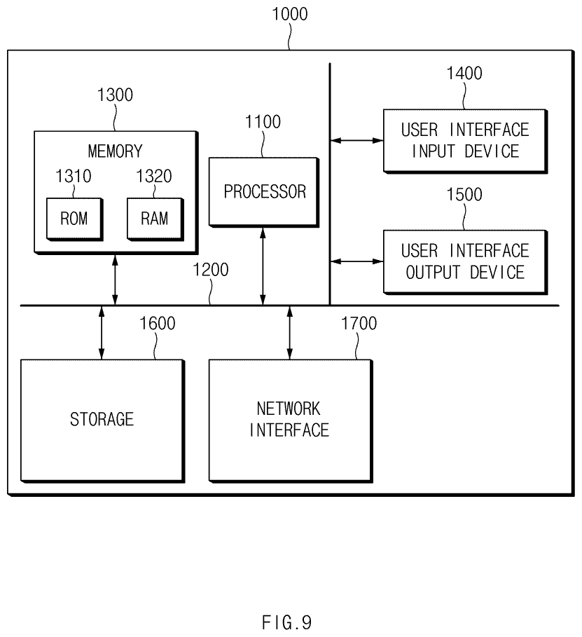

FIG. 9 illustrates a computing system associated with a vehicle control apparatus or a vehicle control method, according to an embodiment of the present disclosure.

Referring to FIG. 9, The computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The present technology may control a hybrid electric vehicle (HEV), based on an HEV mode or an electric vehicle (EV) mode.

The present technology may divide a route from a location of the vehicle to a destination into a plurality of sections and may control the vehicle, using power information corresponding to each of the plurality of sections.

Furthermore, the present technology may predict power and a speed, thus minimizing fuel consumed while driving the vehicle.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus, comprising:
an engine;
a battery;
a processor; and
a memory,
wherein the processor is configured to:
predict a change in speed of a vehicle according to a route of the vehicle;
divide the route into a plurality of sections, using the change in speed;
obtain power information of the vehicle, the power information to vary based on the change in speed, in each of the plurality of sections;
determine reference power for maintaining driving of the engine while driving the vehicle in each of the plurality of sections, using the power information corresponding to each of the plurality of sections; and
control the vehicle, based on at least one of an electric vehicle (EV) mode determined according to the reference power or a hybrid electric vehicle (HEV) mode determined according to the reference power, or any combination thereof.

2. The vehicle control apparatus of claim 1, wherein the processor is configured to:
identify an average speed of the vehicle according to the change in speed, in each of the plurality of sections; and
obtain the power information with dispersion based on the average speed and an average value obtained using wheel torque of the vehicle.

3. The vehicle control apparatus of claim 1, wherein the processor is configured to:
check whether the speed of the vehicle, the speed to vary with the change in speed according to the route, is included within a specified speed range.

4. The vehicle control apparatus of claim 3, wherein the processor is configured to:
obtain the power information, using a setting value, if the speed is included outside the specified speed range during a specified time.

5. The vehicle control apparatus of claim 3, wherein the processor is configured to:
determine a variance value, using at least one of outside weather, the speed, or grade information associated with the route, or any combination thereof, if the speed is included within the specified speed range during a specified time; and
obtain the power information, using the variance value.

6. The vehicle control apparatus of claim 1, wherein the processor is configured to:
obtain the power information, using at least one of speed data associated with the route and obtained before driving the vehicle or grade data associated with the route and obtained before driving the vehicle, or any combination thereof.

7. The vehicle control apparatus of claim 1, wherein the processor is configured to:
determine a state of charge (SOC) of the battery in a last section among the plurality of sections; and
determine the reference power, using the SOC.

8. The vehicle control apparatus of claim 1, wherein the processor is configured to:
obtain ratio information for minimizing fuel corresponding to at least one section in which the vehicle is located among the plurality of sections and consumed while the vehicle is traveling along the route, using the reference power; and
determine the at least one of the EV mode or the HEV mode, or the any combination thereof in the at least one section, using the ratio information.

9. The vehicle control apparatus of claim 8, wherein the processor is configured to:
obtain the ratio information, in a first layer including a dispersion model for obtaining the power information; and
determine the at least one of the EV mode or the HEV mode, or the any combination thereof in the at least one section, using the ratio information, in a second layer including at least one of an acceleration prediction model for controlling the vehicle, a vehicle required power model for controlling the vehicle, or a vehicle control model for controlling the vehicle, or any combination thereof.

10. The vehicle control apparatus of claim 8, wherein the ratio information indicates a ratio between a transit time when the vehicle passes through the at least one section and an HEV time when the vehicle is controlled based on the HEV mode in the at least one section.

11. A vehicle control method, comprising:
predicting a change in speed of a vehicle according to a route of the vehicle;
dividing the route into a plurality of sections, using the change in speed;
obtaining power information of the vehicle, the power information to vary based on the change in speed, in each of the plurality of sections;
determining reference power for maintaining driving of an engine while driving the vehicle in each of the plurality of sections, using the power information corresponding to each of the plurality of sections; and
controlling the vehicle, based on at least one of an electric vehicle (EV) mode determined according to the reference power or a hybrid electric vehicle (HEV) mode determined according to the reference power, or any combination thereof.

12. The vehicle control method of claim 11, wherein the obtaining of the power information includes:
identifying an average speed of the vehicle according to the change in speed, in each of the plurality of sections; and
obtaining the power information with dispersion based on the average speed and an average value obtained using wheel torque of the vehicle.

13. The vehicle control method of claim 11, wherein the obtaining of the power information includes:
checking whether the speed of the vehicle, the speed to vary with the change in speed according to the route, is included within a specified speed range.

14. The vehicle control method of claim 13, wherein the checking of whether the speed of the vehicle is included within the specified speed range includes:
obtaining the power information, using a setting value, if the speed is included outside the specified speed range during a specified time.

15. The vehicle control method of claim 13, wherein the checking of whether the speed of the vehicle is included within the specified speed range includes:
determining a variance value, using at least one of outside weather, the speed, or grade information associated with the route, or any combination thereof, if the speed is included within the specified speed range during a specified time; and
obtaining the power information, using the variance value.

16. The vehicle control method of claim 11, wherein the obtaining of the power information includes:
obtaining the power information, using at least one of speed data associated with the route and obtained before driving the vehicle or grade data associated with the route and obtained before driving the vehicle, or any combination thereof.

17. The vehicle control method of claim 11, wherein the determining of the reference power includes:
determining a state of charge (SOC) of a battery in a last section among the plurality of sections; and
determining the reference power, using the SOC.

18. The vehicle control method of claim 11, wherein the controlling of the vehicle includes:
obtaining ratio information for minimizing fuel corresponding to at least one section in which the vehicle is located among the plurality of sections and consumed while the vehicle is traveling along the route, using the reference power; and
determining the at least one of the EV mode or the HEV mode, or the any combination thereof in the at least one section, using the ratio information.

19. The vehicle control method of claim 18, wherein the determining of the at least one of the EV mode or the HEV mode, or the any combination thereof includes:
obtaining the ratio information, in a first layer including a dispersion model for obtaining the power information; and
determining the at least one of the EV mode or the HEV mode, or the any combination thereof in the at least one section, using the ratio information, in a second layer including at least one of an acceleration prediction model for controlling the vehicle, a vehicle required power model for controlling the vehicle, or a vehicle control model for controlling the vehicle, or any combination thereof.

20. The vehicle control method of claim 18, wherein the ratio information indicates a ratio between a transit time when the vehicle passes through the at least one section and an HEV time when the vehicle is controlled based on the HEV mode in the at least one section.
